(19) United States
(12) Patent Application Publication
(10) Pub. No.: US 2012/0236287 A1
(43) Pub. Date: Sep. 20, 2012

(54) EXTERNAL ENVIRONMENT VISUALIZATION APPARATUS AND METHOD

(75) Inventors: Jae Yeong LEE, Daejeon (KR); Hee Sung CHAE, Daejeon (KR); Seung Hwan PARK, Daejeon (KR); Won Pil YU, Ulsan (KR)

(73) Assignee: ELECTRONICS AND TELECOMMUNICATIONS RESEARCH INSTITUTE, Daejeon (KR)

(21) Appl. No.: 13/351,374

(22) Filed: Jan. 17, 2012

(30) Foreign Application Priority Data
Mar. 16, 2011 (KR) 10-2011-0023396

(51) Int. Cl. G01C 3/08

(52) U.S. Cl. 356/4.01

(57) ABSTRACT

The present invention adjusts images received from plural cameras that are oriented to plural directions and combines the images with distance information. Thereafter, the circumstantial environment is visualized based on a moving object using an augmented reality technique to provide to a user. Specifically, the present invention adjusts images in plural directions and adds the distance information to improve the accuracy and uses a visualization method that displays the images with respect to the moving object.

### CROSS-REFERENCE TO RELATED APPLICATIONS

This application claims priority to and the benefit of Korean Patent Application No. 10-2011-0023396 filed in the Korean Intellectual Property Office on Mar. 16, 2011, the entire contents of which are incorporated herein by reference.

### TECHNICAL FIELD

The present invention relates to an external environment visualization apparatus and a method thereof, and more specifically, to an apparatus and a method for visualization of an external environment of a moving object such as a vehicle or a robot.

### BACKGROUND ART

A user located in a moving object such as a vehicle receives and utilizes only visual information in a direction that the user glances at a certain moment such as a front or a side due to a limited viewing angle. This gives insufficient recognition information regarding the circumstantial environment to an operator, which results in lowering operation efficiency or increasing possibility of a serious accident.

In order to prevent the above problems, recently a method for securing operational safety by providing an image of an interested region at the corresponding moment to the user using a vision sensor such as a rear view camera and a side camera is used. Specifically, some premium vehicles have a function of adjusting images from the side camera and rear view camera to accurately show the environment within a close range around the vehicle using a top-view method. For this function, a camera calibration, an image distortion compensation, and precise adjustment technology are used.

However, since the images actually received through a lens do not have distance information as if it is sensed by the human eyes, the images are significantly distorted when the user views the images. Therefore, it is difficult for the user to understand the images as it is. Moreover, in order to solve the above problems, image distortion compensation and image operation are required and image adjustment technology is further required to make information received from several cameras to be easily recognized by the user based on an augmented reality technology.

Specifically, even though the vision sensor may recognize lots of information at one moment, if a stereo camera is not used, since distance information is not included, it is difficult to utilize the information as it is.

### SUMMARY OF THE INVENTION

The present invention has been made in an effort to provide an external environment visualization apparatus and a method thereof that measure and visualize an external environment of a moving object by combining multiple image information and distance information.

An exemplary embodiment of the present invention suggests an external environment visualization apparatus, including: a multiple image capturing unit configured to capture multiple images regarding an external environment; a distance measuring unit configured to measure a distance to at least one object included in an image when at least one image included in the multiple images is captured; a distance reflecting unit configured to reflect the distance to an image whose distance is measured; and a multiple image displaying unit configured to display the multiple images based on the image whose distance is reflected.

The multiple image capturing unit and the distance measuring unit may be mounted in a moving object which is a reference for defining the external environment or the external environment visualization apparatus is mounted in the moving object.

The external environment visualization apparatus may further include an image compensating unit configured to compensate the distortion of the captured images using a reference image; and an image adjusting unit configured to adjust the distortion-compensated images. The multiple image displaying unit may display the multiple images based on the adjusted images. When the distance is reflected to the adjusted images, the multiple image displaying unit may display the multiple images based on the adjusted image. The multiple image displaying unit may display the multiple image as a 2.5D image when the external environment is visualized. Displaying of the 2.5D image means that as shown in FIG. 4B, while showing adjusted and distortion-compensated top-view image, circumstantial objects (vehicles, wall, or pedestrians) discovered from the measured distance are added onto the image as a 3D virtual prototype.

The distance measuring unit may measure the distance whenever the respective images that form the multiple images are captured.

The multiple image capturing unit may include vision sensors that are oriented to different locations and whose orientation positions or orientation angles can be changed.

Another exemplary embodiment of the present invention suggests an external environment visualization method, including: a multiple image capturing step of capturing multiple images regarding an external environment; a distance measuring step of measuring a distance to at least one object included in an image when at least one image included in the multiple images is captured; a distance reflecting step of reflecting the distance to an image whose distance is measured; and a multiple image displaying step of displaying the multiple images based on the image whose distance is reflected. The multiple image displaying step may display multiple images based on an image when the distance is reflected to the adjusted image. The multiple image displaying step may display the multiple images as a 2.5D image when the external environment is visualized. The displaying of 2.5D image is described above, and thus the description thereof will be omitted.

Between the multiple image capturing step and the distance measuring step, or between the distance measuring step and the distance reflecting step, an image compensating step of compensating the distortion of the captured images using a reference image; and an image adjusting step of adjusting the distortion-compensated images may be included. The multiple image displaying step may display the multiple images based on the adjusted images.

The distance measuring step may measure the distance whenever the respective images that form the multiple images are captured.

The multiple image capturing step may use vision sensors that are oriented to different locations and whose orientation positions or orientation angles can be changed.

Exemplary embodiments of the present invention suggest a visualization apparatus that is mounted in a moving object to show a circumstantial environment of the moving object to be understandable and a method thereof. According to the exemplary embodiments, a vision sensor and a distance sensor are combined to obtain more accurate circumstantial information, and image visualization that allows a user to easily understand the circumstantial environment is carried out based on the information to increase the efficiency of providing information. Further, the user can intuitively and quickly understand the circumstantial environment and safely manipulate the moving object.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic block diagram illustrating an external environment visualization apparatus according to an exemplary embodiment of the present invention.

FIG. 2 is a schematic block diagram illustrating components that are added to the external environment visualization apparatus according to an exemplary embodiment of the present invention.

FIG. 3 is a diagram illustrating an example of the external environment visualization apparatus according to an exemplary embodiment of the present invention.

FIGS. 4 and 5 are conceptual diagrams showing two image visualization methods.

FIG. 6 is a conceptual diagram showing a situation where an external environment visualization apparatus according to an exemplary embodiment of the present invention is driven in a moving object.

FIG. 7 is a flow chart illustrating an external environment visualization method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. Further, in the description of this invention, if it is determined that the detailed description of the configuration or function of the related art may unnecessarily deviate from the gist of the present invention, the detailed description of the related art will be omitted. Hereinafter, preferred embodiment of this invention will be described. However, the technical idea is not limited thereto, but can be modified or performed by those skilled in the art.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

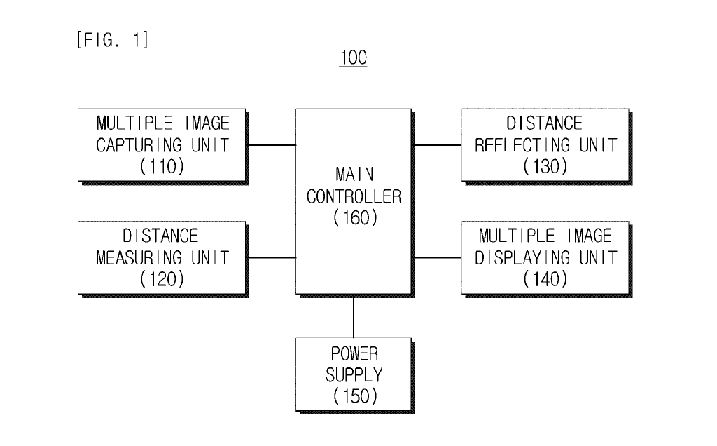

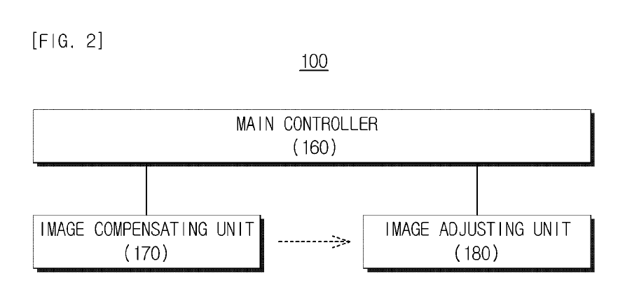

FIG. 1 is a schematic block diagram illustrating an external environment visualization apparatus according to an exemplary embodiment of the present invention. FIG. 2 is a schematic block diagram illustrating components that are added to the external environment visualization apparatus according to an exemplary embodiment of the present invention. An exemplary embodiment will be described with reference to FIGS. 1 and 2.

Referring to FIG. 1, an external environment visualization device 100 includes a multiple image capturing unit 110, a distance measuring unit 120, a distance reflecting unit 130, a multiple image displaying unit 140, a power supply 150, and a main controller 160.

The external environment visualization device 100 is a device for combining distance information measured by a distance sensor with image information received by plural vision sensors to measure information regarding environment around a moving object with a sensor mounted therein and visualize the information to be comprehensible by a user.

The external environment visualization device 100 is mounted in a moving object, for example, a vehicle or a robot, which is a reference for defining an external environment. In the exemplary embodiment, among components of the external environment visualization device 100, only the multiple image capturing unit 110 and the distance measuring unit 120 may be mounted in the moving object.

The multiple image capturing unit 110 is configured to capture multiple images of the external environment. The multiple image capturing unit 110 is the same concept as a vision sensor 310 which will be described below. In the above description, the external environment refers to an external environment of the moving object, for example, a vehicle or a robot.

The multiple image capturing unit 110 may include vision sensors that are oriented to different locations and whose orientation positions or orientation angles can be changed. If the multiple image capturing unit 110 includes vision sensors that are oriented to different locations, the multiple image displaying unit 140 is very advantageous for image visualization and can display an image that matches with what can be viewed by the human eyes.

The distance measuring unit 120 is configured to measure a distance to at least one object included in an image when at least one image included in the multiple images is captured. The distance measuring unit 120 can measure the distance whenever every image forming the multiple images is captured. The distance measuring unit 120 is the same concept as a distance sensor 330 which will be described below.

The distance reflecting unit 130 is configured to reflect the distance to an image whose distance is measured. The multiple image displaying unit 140 is configured to display multiple images based on the image to which the distance is reflected. The distance reflecting unit 130 and the multiple image displaying unit 140 are the same concept as an image visualization device 340 which will be described below.

The power supply 150 is configured to supply power to respective components of the external environment visualization apparatus 100.

The main controller 160 is configured to control overall operations of the components of the external environment visualization apparatus 100.

As shown in FIG. 2, the external environment visualization apparatus 100 may further include an image compensating unit 170 and an image adjusting unit 180.

The image compensating unit 170 is configured to compensate the distortion of the captured images using a reference image. The image adjusting unit 180 is configured to adjust the distortion-compensated images. The image compensating unit 170 and the image adjusting unit 180 are the same concept of an image compensation and adjustment device 320 which will be described below. In the above description, an image that is captured from the same external environment in advance may be a candidate of a reference image. Otherwise, an image selected from the captured multiple images can be a candidate of a reference image.

The multiple image displaying unit 140 displays the multiple images based on the adjusted images. At this time, the multiple image displaying unit 140 displays the multiple images using only adjusted images excluding the distance. According to the exemplary embodiment, if the distance reflecting unit 130 reflects the distance to the adjusted image, the multiple image displaying unit 140 may display multiple images based on the above image.

As described above, in order to increase the recognition accuracy and reliability for the circumstantial environment of the moving object, the external environment visualization apparatus 100 combines the image information and the distance information and visualizes the combined information so that the user can easily recognize the circumstantial environment. The external environment visualization apparatus 100 compensates for the disadvantages of the image information used to recognize the circumstantial environment of the moving object using the distance information and visualizes the images so as to easily and precisely recognize information regarding the circumstantial environment, which is different from the prior art.

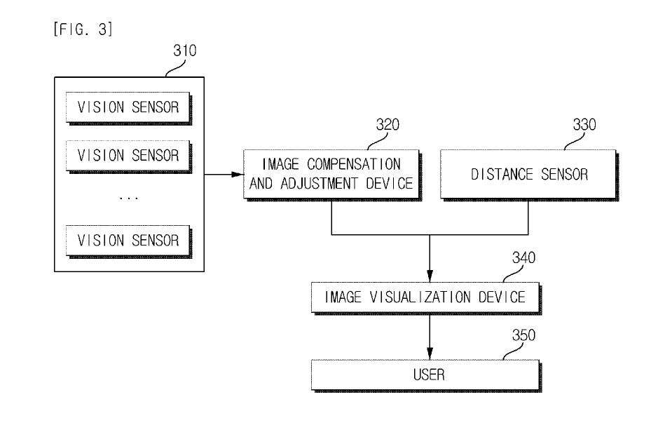

Next, an embodiment of the external environment visualization apparatus 100 will be described. FIG. 3 is a diagram illustrating an example of the external environment visualization apparatus according to an exemplary embodiment of the present invention. Hereinafter, the exemplary embodiment will be described with reference to FIG. 3.

A device that combines the multiple image information and the distance information to measure and visualize the external environment of the moving object, that is, the external environment visualization apparatus compensates and adjusts the image information input from plural vision sensors and then combines the distance information with the image information in response to the user's request and performs the visualization. The external environment visualization apparatus according to the exemplary embodiment may subject the visualization on only the adjusted images.

As shown in FIG. 3, the external environment visualization apparatus includes a plurality of vision sensors 310, an image compensation and adjustment device 320, a distance sensor 330, and an image visualization device 340.

The vision sensor 310 is configured to get image information. The image compensation and adjustment device 320 is configured to compensate the distortion of the input image and adjust the plural images. The distance sensor 330 is used to increase the accuracy of the image information. The image visualization device 340 is selected depending on request of a user 350.

The vision sensor 310 refers to a device that is configured to receive image information using a CCD, a CMOS, or other light receiving elements. A web camera that is widely being used or a higher quality camera may be used as the vision sensor. Since the environment information to be received is omnidirectional information of 360 degrees with respect to the moving object, at least two vision sensors are used. In case of a fish-eye type vision sensor, one vision sensor is used to view omnidirectional information. However, the fish-eye type vision sensor outputs different types of image information from the general type. Further, it is difficult to achieve the visualization of the image, which is the final result. Therefore, two or more fish-eye type vision sensors should be used.

In a case of an environmental image reproducing device that is currently used in the vehicle, three cameras located at a rear side, a left side, and a right side are used. The camera is mounted in a predetermined location in the moving object and is precisely calibrated in advance in order to acquire precise information.

Further, in order to acquire long distance and short distance image information, when the vision sensor 310 is mounted in the moving object, the mounting angle is adjusted corresponding to the situation. As the viewing field distance of the vision sensor 310 is longer, the amount of information to be received is increased but the resolution is decreased. In contrast, as the viewing field distance is shorter, the amount of information to be received at one time is decreased but the resolution is increased. Accordingly, at the time of utilizing the image information, it is advantageous that when the short distance information such as parking of a car is needed, the viewing field distance is reduced to increase the details of the environmental information. Further, the viewing field distance is increased to expand the visible area during driving. The adjustment interval of the mounting angle is basically set for a long distance range and a short distance range. If necessary, the interval is increased so as to utilize various information according to the distance.

The image compensation and adjustment device 320 compensates and pastes the various images received from the vision sensors 310 so as to be viewable by the user. There are a compensation device that compensates for the image distortion and an adjustment device that combines plural images without errors. Generally, the image information output from the vision sensor 310 is distorted as it goes from the center of the image to the edge thereof. Specifically, in case of a wide angle camera having a wide viewing angle, the distortion is significant so that the analysis of the image information is difficult. Therefore, the distortion of the input individual image information is compensated before performing the next processes to be changed to the normal image. In the plural image information to which the above process is subjected, the overlapping or connected part for every image is appropriately adjusted to create a single image so that the user can easily view. The image adjustment device performs the above process. Since the location of the moving object where the vision sensor 310 is mounted is fixed, location information regarding the edge of an image that is received by a sensor, that is, information regarding which pixel is connected with which part in the actual environment is also previously determined. Therefore, when the edge information is used, the image adjustment process may be easily performed.

The distance sensor 330 is configured to measure the distance to the surrounding obstacles and includes an ultrasonic sensor, an infrared sensor or a laser range finder that is used to increase the accuracy of the environment information acquired from the image. Even though only one distance sensor is shown in FIG. 3, plural distance sensors can be used depending on the purpose. The distance sensor 330 does not need to be used for visualization process that simply reproduces the adjusted image with respect to the moving object, but may be used in case of performing a 2.5D virtual space realization.

In the exemplary embodiment, the distance sensor 330 may use a TOF (time of flight) method that uses an ultrasonic wave or light to measure the reflection time to a target object. Accordingly, a laser range finder that uses predetermined wavelength light may be used as the distance sensor 330. Since the velocity of laser is high and the scattered amount is small even when the light proceeds at a long distance, the obtained distance measurement value is very precise. However, the laser range finder is very expensive. The laser sensor that is generally used sequentially scans one laser beam at an interval of a predetermined angle and senses the reflected light to measure the distance to the object in the predetermined range. In a more developed case, plural laser beams are simultaneously used to sense all front objects at one measurement.

As compared with the accuracy and expensive price of the laser, the ultrasonic sensor has opposite properties to the laser range finder. Since the diffusion range depending on the distance is large due to the characteristics of the sound wave, the ultrasonic sensor is not preferable to measure the long distance nor to precisely measure the narrow range. However, the ultrasonic sensor is inexpensive and easy to handle so as to be often used for a low cost application. However, in this case, the ultrasonic sensor is necessary to have a compensation algorithm for various factors which reduce the accuracy, such as inputting of an error signal due to a second or third reflection with respect to the environment or sensing of a signal output from other sensors.

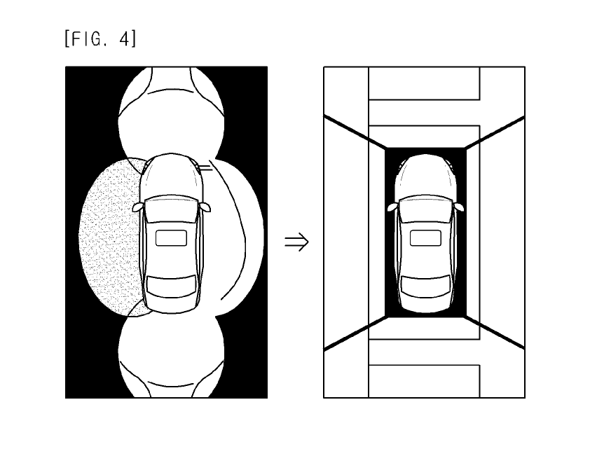

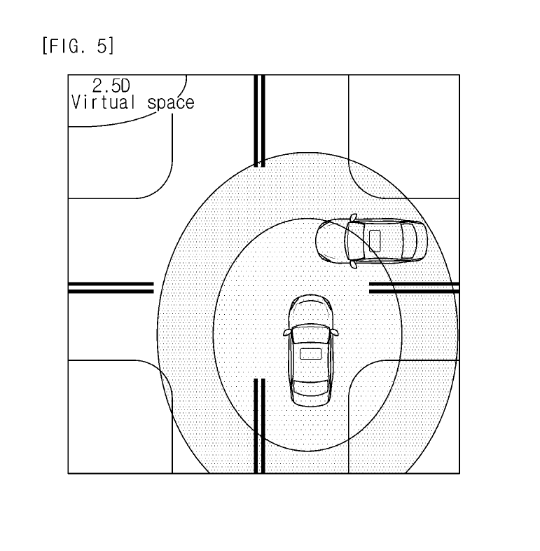

The image visualization device 340 refers to a device that shows image information to which adjustment and a combination process with the distance information are subjected to a user with respect to the moving object. The image visualization is performed by two methods of a method using only image information as shown in FIG. 4 or a method using both image information and distance information as shown in FIG. 5 to show a 2.5D virtual space, and the method may be converted in response to the selection of a user.

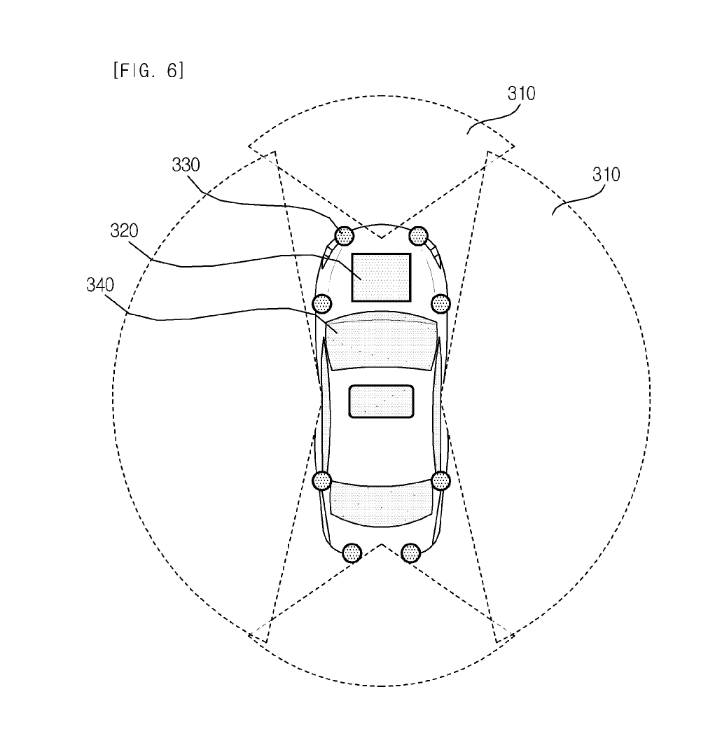

An exemplary embodiment is shown in FIG. 6. FIG. 6 is a conceptual diagram showing a situation where an external environment visualization apparatus is driven in a moving object. The exemplary embodiment will be described below with reference to FIG. 6.

As described above, the exemplary embodiment uses the vision sensor 310 as a basic device to acquire the environment information. In this case, the sensing area of the vision sensors should include all directions of 360 degrees with respect to the moving object. Further, in order to increase the accuracy of the environment information, the distance sensor 330 is used. The number of distance sensors 330 may be determined depending on the type and function of the sensor and the distance sensor 330 needs to also sense the omnidirectional area of 360 degree with respect to the moving object. The image information received from the vision sensor 310 is processed by the image compensation and adjustment device 320 and combined with the information of the distance sensor 330 or sent to the image visualization device 340 as it is. The image compensation and adjustment device 320 may be operated as individual devices or included in the image visualization device.

The image visualization device includes a display device that may be attached into the moving object. If the image information is shown with respect to the moving object using a top view method, the user can most easily and quickly understand the surroundings. Further, in response to the selection of the user, image information including the distance information is shown as the 2.5D type images or image information that does not include the distance information is shown. When the 2.5D type visualization is used, the object is simplified with respect to the distance to the obstacle closest to the moving object rather than the detail description for the surrounding objects to be represented so that the situation such as collision is quickly predicted. If necessary, the user converts the image information into actual image information so that the circumstantial environment can be more accurately checked.

The exemplary embodiment of the present invention can be used for both short range and long range radii with respect to the moving object. For example, in the case of focusing attention within the short range such as parking of a car, the angle of the vision sensor is adjusted to narrow the viewing distance and acquire the more detailed environmental information. In contrast, during driving at a high speed, the circumstantial information for longer distance is acquired by widening the viewing field and the precision is reduced to allow quick image processing. In any of the cases, the user uses the image visualization device to recognize the circumstantial environment of the moving object.

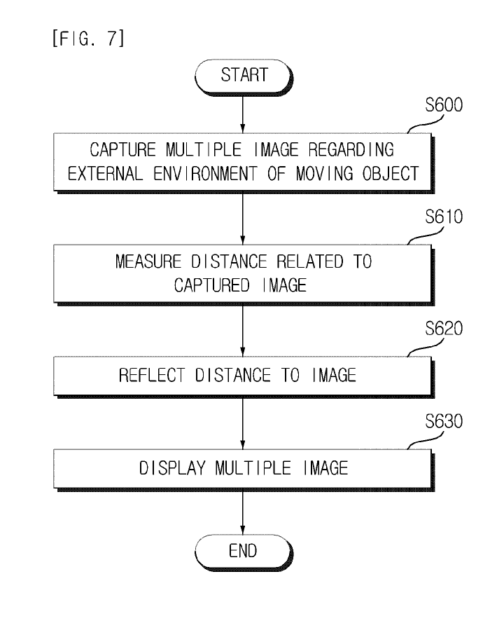

Next, the external environment visualization method of the external environment visualization apparatus 100 will be described. FIG. 7 is a flow chart illustrating an external environment visualization method according to an exemplary embodiment of the present invention. The exemplary embodiment will be described below with reference to FIG. 7.

First, multiple images regarding the external environment is captured (multiple image capturing step, S600). The multiple image capturing step S600 uses vision sensors that are oriented at different locations and whose orientation positions or orientation angles can be changed.

After the multiple image capturing step S600, when at least one of the images included in the multiple images is captured, a distance to at least one object, which is included in the image (distance measuring step S610). The distance measuring step S610 measures a distance whenever respective images that form the multiple images are captured.

After the distance measuring step S610, the measured distance is reflected to the image whose distance is measured (distance reflecting step S620).

Thereafter, the multiple images are displayed based on the image whose distance is measured (multiple image displaying step S630). The multiple image displaying step S630 displays the multiple image based on the adjusted image.

According to the exemplary embodiment, an image compensation step and an image adjustment step may be performed between the multiple image capturing step S600 and the distance measuring step S610. The image compensation step refers to a step that compensates the distortion of images captured using the reference image. The image adjustment step refers to a step that adjusts the distortion-compensated images. The image compensation step and the image adjustment step may be performed between the distance measuring step S610 and the distance reflecting step S620.

The exemplary embodiment of the present invention may be mounted in a moving object such as a vehicle or a robot and applied to autonomous driving technologies. Further, the present invention can contribute to the development of autonomous driving technologies that is strong in the external environment.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An external environment visualization apparatus, comprising:
a multiple image capturing unit configured to capture multiple images regarding an external environment;
a distance measuring unit configured to measure a distance to at least one object included in an image when at least one image included in the multiple images is captured;
a distance reflecting unit configured to reflect the distance to an image whose distance is measured; and
a multiple image displaying unit configured to display the multiple images based on the image whose distance is reflected.

2. The apparatus of claim 1, wherein the multiple image capturing unit and the distance measuring unit are mounted in a moving object which is a reference for defining the external environment or the external environment visualization apparatus is mounted in the moving object.

3. The apparatus of claim 1, further comprising:
an image compensating unit configured to compensate the distortion of the captured images using a reference image; and
an image adjusting unit configured to adjust the distortion-compensated images.

4. The apparatus of claim 3, wherein the multiple image displaying unit displays the multiple images based on the adjusted images.

5. The apparatus of claim 1, wherein the distance measuring unit measures the distance whenever the respective images that form the multiple images are captured.

6. The apparatus of claim 1, wherein the multiple image capturing unit includes vision sensors that are oriented to different locations and whose orientation positions or orientation angles can be changed.

7. An external environment visualization method, comprising:
a multiple image capturing step of capturing multiple images regarding an external environment;
a distance measuring step of measuring a distance to at least one object included in an image when at least one image included in the multiple images is captured;
a distance reflecting step of reflecting the distance to an image whose distance is measured; and
a multiple image displaying step of displaying the multiple images based on the image whose distance is reflected.

8. The method of claim 7, further comprising:
an image compensating step of compensating the distortion of the captured images using a reference image;
and an image adjusting step of adjusting the distortion-compensated images.

9. The method of claim 8, wherein the multiple image displaying step displays the multiple images based on the adjusted images.

10. The method of claim 7, wherein the distance measuring step measures the distance whenever the respective images that form the multiple images are captured.

11. The method of claim 7, wherein the multiple image capturing step uses vision sensors that are oriented to different locations and whose orientation positions or orientation angles can be changed.
